(19) United States
(12) Patent Application Publication
(10) Pub. No.: US 2014/0312029 A1
(43) Pub. Date: Oct. 23, 2014

(54) Flexible, Low-Profile Heating Cable

(71) Applicants: Craig M. Berger, Stockbridge, MA (US); Rosalie Berger, Stockbridge, MA (US)

(72) Inventor: Craig M. Berger, Stockbridge, MA (US)

(73) Assignees: Rosalie Berger, Stockbridge, MA (US); Craig M. Berger, Stockbridge, MA (US)

(21) Appl. No.: 14/225,158

(22) Filed: Mar. 25, 2014

Related U.S. Application Data
(60) Provisional application No. 61/804,986, filed on Mar. 25, 2013.

(51) Int. Cl. H05B 3/56; H05B 3/14

(52) U.S. Cl. CPC H05B 3/565; H05B 3/145
USPC 219/539

(57) ABSTRACT

A flexible, low-profile heating cable with a first buss conductor, a second buss conductor, a plurality of carbon-based resistive heating elements, the heating elements connected to the first and second busses at connection nodes, high-temperature polymer-based electrical insulating thermally-conductive layers between the heating elements and the buss conductors, except at the node locations, a conductive ground member, a high-temperature polymer-based electrical insulating thermally-conductive layer between the ground member and the buss conductors, and a thermally-conductive over-jacket outside of the ground member.

### CROSS-REFERENCE TO RELATED APPLICATION

This application claims benefit from U.S. Provisional Patent Application No. 61/804,986, filed on Mar. 25, 2013, the contents of which are incorporated herein by reference.

### BACKGROUND

This disclosure relates to a heating cable.

Flexible heating cables can be used for many purposes and in many locations. Flat cables can be easier to manipulate and fit into constrained spaces.

### SUMMARY

All examples and features mentioned below can be combined in any technically possible way.

A flexible, low-profile heating cable is disclosed herein. The heating cable includes first and second buss tape conductors. There are a number of carbon-based tape resistive heating elements. The heating elements are connected to the first and second buss tapes at connection nodes. The heating elements may be of constant wattage or may exhibit a positive temperature coefficient. There are high-temperature polymer-based electrical insulating thermally-conductive layers between the heating elements and the buss conductors, except at the node locations. There is a conductive ground tape or braid with a high-temperature polymer-based electrical insulating thermally-conductive layer between the ground tape or braid and the buss conductors. There is a thermally-conductive over-jacket outside of the ground tape or braid.

Non-limiting examples of the disclosed flexible, low-profile heating cable are shown in the drawings. FIG. 1 is a schematic cross-sectional diagram of a flexible, low-profile heating cable. FIG. 2 is an electrical schematic diagram of a flexible, low-profile heating cable. FIG. 3 illustrates electrical connectivity of a flexible, low-profile heating cable. FIG. 4 illustrates electrical connectivity of another flexible, low-profile heating cable. FIG. 5 is a cross-sectional view of a flexible, low-profile heating cable.

In one aspect, a flexible, low-profile heating cable includes a first buss conductor, a second buss conductor, a plurality of carbon-based resistive heating elements, the heating elements connected to the first and second busses at connection nodes, high-temperature polymer-based electrical insulating thermally-conductive layers between the heating elements and the buss conductors, except at the node locations, a conductive ground member, a high-temperature polymer-based electrical insulating thermally-conductive layer between the ground member and the buss conductors, and a thermally-conductive over-jacket outside of the ground member.

Embodiments may include one of the following features, or any combination thereof. The resistive heating elements may be constant voltage or positive temperature coefficient heating elements. The buss conductors may comprise flexible conductive tapes. The heating elements may comprise flexible conductive tapes. The ground member may comprise a flexible tape or braid.

Embodiments may include one of the above and/or below features, or any combination thereof The ground member may surround the busses, the heating elements, the high-temperature polymer-based electrical insulating thermally-conductive layers between the heating elements and the buss conductors, except at the node locations, and a high-temperature polymer-based electrical insulating thermally-conductive layer between the ground member and the buss conductors. The over jacket may surround the ground member. The resistive heating elements may be constant voltage or positive temperature coefficient heating elements, and the buss conductors may comprise flexible conductive tapes. The heating elements may comprise flexible conductive tapes. The ground member may comprise a flexible tape or braid. The ground member may surround the busses, the heating elements, the high-temperature polymer-based electrical insulating thermally-conductive layers between the heating elements and the buss conductors, except at the node locations, and the high-temperature polymer-based electrical insulating thermally-conductive layer between the ground member and the buss conductors. The over jacket may surround the ground member.

### BRIEF DESCRIPTION OF THE DRAWINGS

FIG. 1 is a highly schematic cross-sectional diagram of a flexible, low-profile heating cable.

FIG. 2 is an electrical schematic diagram of a flexible, low-profile heating cable.

FIG. 3 illustrates electrical connectivity of a flexible, low-profile heating cable.

FIG. 4 illustrates electrical connectivity of another flexible, low-profile heating cable.

FIG. 5A is an exaggerated cross-sectional perspective view of a flexible, low-profile heating cable.

FIG. 5B is a greatly exaggerated cross-sectional view of the flexible, low-profile heating cable of FIG. 5A.

### DETAILED DESCRIPTION

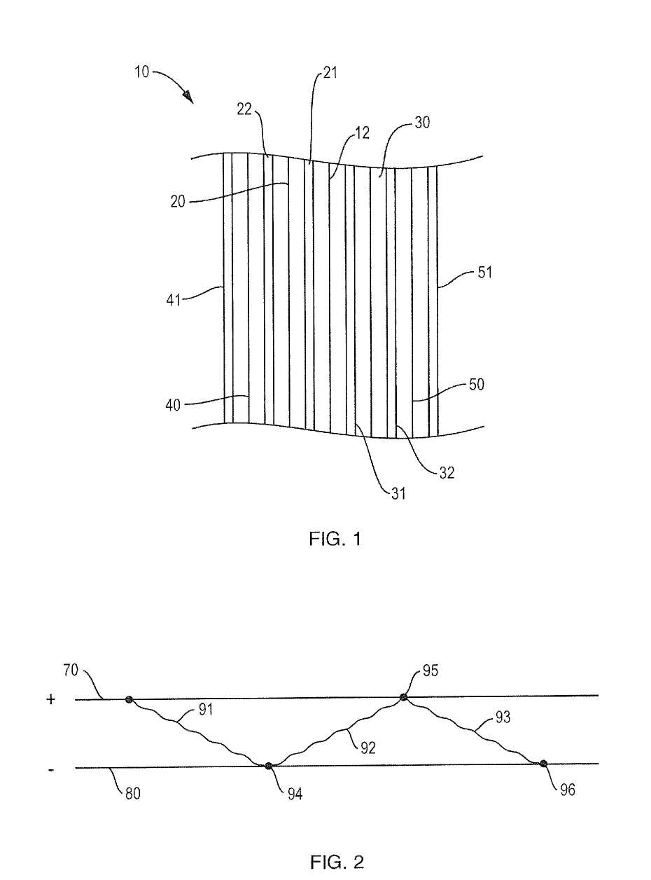

FIG. 1 depicts very schematically an example of a flexible, low-profile heating cable 10. Cable 10 includes flexible conductive (resistive) heater tape 12, which may be but need not be a carbon-based fiber or mesh resistive material. Other resistive materials could be used for the heater tape. Tape 12 preferably but not necessarily exhibits a positive temperature coefficient. High-temperature polymer-based heat-conductive dielectric layers 21 and 31 are located between heater tape 12 and buss tapes 20 and 30. Buss tapes 20 and 30 are typically but not necessarily copper ribbon cable, but could be of other materials that are used for flexible busses. Busses 20 and 30 are connected to the positive and negative terminals of a DC or AC power source (not shown). High-temperature polymer-based heat-conductive dielectric layers 22 and 32 are located between busses 20 and 30 and conductive ground layers 40 and 50. Layers 40 and 50 may be but need not be made from a conductive tape or braid. The outer portion comprises thermally-conductive over-jacket layers 41 and 51. The over-jacket can be made from any desirable heat conducting material that can withstand the temperatures created in the heating cable. One non-limiting example is a thermally-conductive, high-temperatures polymer.

The heater tape comprises a number of segments or lengths that are connected to the busses. This is schematically depicted in FIG. 2 where heater tape segments 91-93 are connected at each end to buss 70 and buss 80. The segments can be connected in parallel and/or series. The segments terminate at nodes 94-96, shown as dots in the drawing. The nodes for adjacent segments can be in common (as shown), or can be separate.

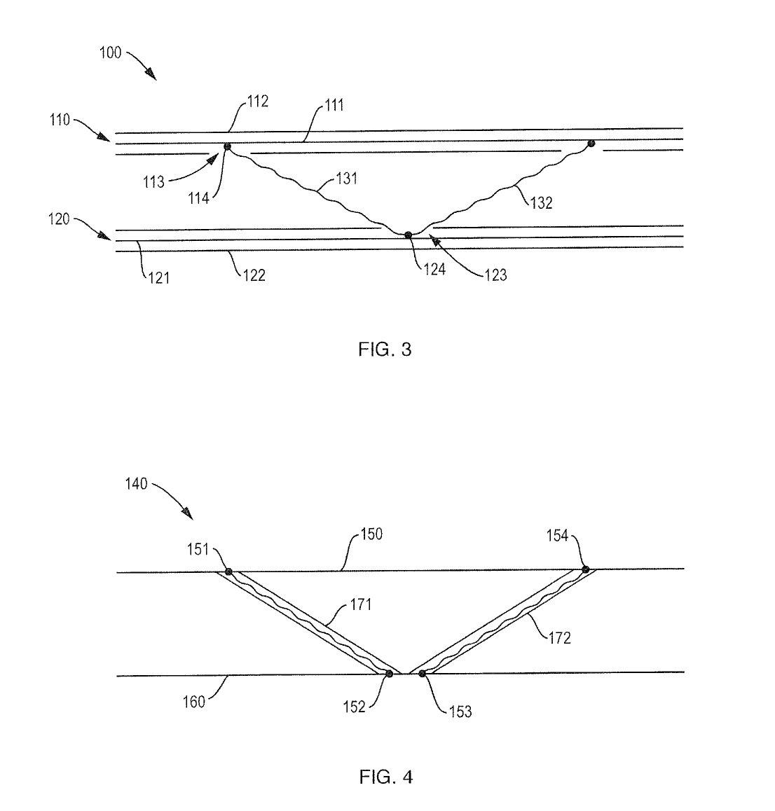

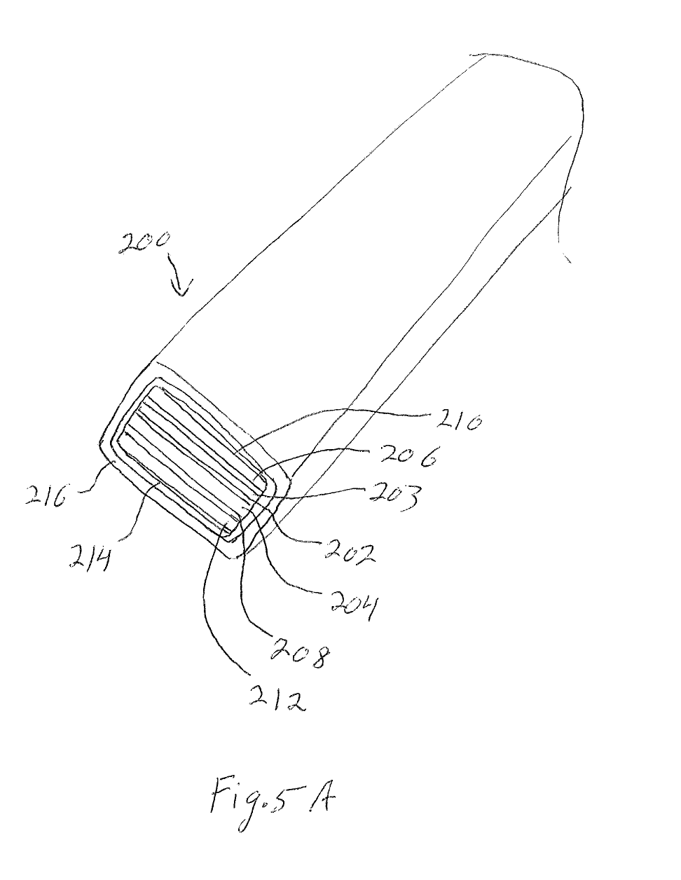

The insulating layers between the heater tape and the busses can separate layers, or can be coupled to the busses as shown in FIG. 3, or coupled to the heater tape as shown in FIG. 4. In FIG. 3, heater/buss assembly 100 includes buss assembly 110 that includes buss 111 and high-temperature polymer-based heat-conductive dielectric layer 112 that surrounds buss 111. Similarly, buss assembly 120 includes buss 121 and high-temperature polymer-based heat-conductive dielectric layer 122 that surrounds buss 121. Openings 113 and 123 are created in the insulators to allow for mechanical or solder-based electrical connection at nodes 114 and 124.

In FIG. 4, heater segments 171 and 172 each include the heater conductive tape surrounded by an insulator. The heater segments terminate at nodes on the busses 150 and 160. Heater segment 171 terminates at nodes 151 and 152. Heater segment 172 terminates at nodes 153 and 154.

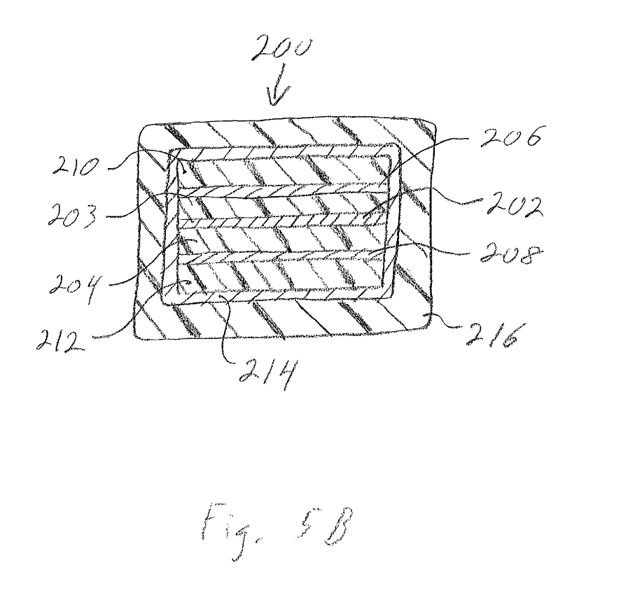

One physical example is shown (greatly enlarged and with exaggerated dimensions) in FIGS. 5A and 5B, which are greatly enlarged and have exaggerated dimensions so as to illustrate features of the cable 200. In actuality, the cable would normally be wider and thinner than illustrated in these figures. Each of the several elements of cable 200 can be configured as described above relative to FIGS. 1-4. Flexible, low-profile heating cable 200 includes elongated planar heating element or tape 202 overlaid by insulating layers 203 and 204, which are overlaid by busses 206 and 208, which are overlaid by insulating layers 210 and 212. Ground layer 214 surrounds the assembly. Ground layer 214 is itself surrounded by insulating over-jacket 216.

The cable disclosed herein can have the following characteristics, which are exemplary of examples of the innovative cable. However, the cable does not need to have these characteristics and need not have all of these characteristics:
a Nominal thickness: 0.100 to 0.500″
Flexible
Tape format; lengths from 3′ to 1000′ or longer depending on voltage drop considerations
Can be cut to length
Constant wattage or positive temperature coefficient
Carbon fiber or mesh heater tape
Power output of 3 to 60 Watts per linear foot
Voltage: 12-3000 VDC; 110-600 VAC
Heater segments in series and/or parallel
Buss tapes electrically insulated from heater tape
Buss tapes are flat
Uses thermally conductive polymers
Meets all applicable sections of IEEE 515-2011
Small, lightweight, thin, flat, flexible, thermally conductive, thermally efficient, electrically-efficient, low-cost heater cable.

The subject cable can be used in a variety of applications where a flexible heating cable is needed. Two of many possible applications include a pipe wrap (for freeze protection) and a contact railroad rail deicer.

A number of implementations have been described. Nevertheless, it will be understood that additional modifications may be made without departing from the scope of the inventive concepts described herein, and, accordingly, other embodiments are within the scope of the following claims.

What is claimed is:

1. A flexible, low-profile heating cable, comprising:
a first buss conductor;
a second buss conductor;
a plurality of carbon-based resistive heating elements, the heating elements connected to the first and second busses at connection nodes;
high-temperature polymer-based electrical insulating thermally-conductive layers between the heating elements and the buss conductors, except at the node locations;
a conductive ground member;
a high-temperature polymer-based electrical insulating thermally-conductive layer between the ground member and the buss conductors; and
a thermally-conductive over-jacket outside of the ground member.

2. The heating cable of claim 1 wherein the resistive heating elements are constant voltage or positive temperature coefficient heating elements.

3. The heating cable of claim 1 wherein the buss conductors comprise flexible conductive tapes.

4. The heating cable of claim 1 wherein the heating elements comprise flexible conductive tapes.

5. The heating cable of claim 1 wherein the ground member comprises a flexible tape or braid.

6. The heating cable of claim 5 wherein the ground member surrounds the busses, the heating elements, the high-temperature polymer-based electrical insulating thermally-conductive layers between the heating elements and the buss conductors, except at the node locations, and the high-temperature polymer-based electrical insulating thermally-conductive layer between the ground member and the buss conductors.

7. The heating cable of claim 1 wherein the over jacket surrounds the ground member.

8. The heating cable of claim 1 wherein the resistive heating elements are constant voltage or positive temperature coefficient heating elements and buss conductors comprise flexible conductive tapes.

9. The heating cable of claim 1 wherein the resistive heating elements are constant voltage or positive temperature coefficient heating elements, the buss conductors comprise flexible conductive tapes and the heating elements comprise flexible conductive tapes.

10. The heating cable of claim 1 wherein the resistive heating elements are constant voltage or positive temperature coefficient heating elements, the buss conductors comprise flexible conductive tapes, the heating elements comprise flexible conductive tapes and the ground member comprises a flexible tape or braid.

11. The heating cable of claim 1 wherein the resistive heating elements are constant voltage or positive temperature coefficient heating elements, the buss conductors comprise flexible conductive tapes, the heating elements comprise flexible conductive tapes and the ground member comprises a flexible tape or braid; and
wherein the ground member surrounds the busses, the heating elements, the high-temperature polymer-based electrical insulating thermally-conductive layers between the heating elements and the buss conductors, except at the node locations, and the high-temperature polymer-based electrical insulating thermally-conductive layer between the ground member and the buss conductors.

12. The heating cable of claim 1 wherein the resistive heating elements are constant voltage or positive temperature coefficient heating elements, the buss conductors comprise flexible conductive tapes, the heating elements comprise flexible conductive tapes, the ground member comprises a flexible tape or braid and the over jacket surrounds the ground member; and
wherein the ground member surrounds the busses, the heating elements, the high-temperature polymer-based electrical insulating thermally-conductive layers between the heating elements and the buss conductors, except at the node locations, and the high-temperature polymer-based electrical insulating thermally-conductive layer between the ground member and the buss conductors.
